(19) United States
(12) Patent Application Publication
(10) Pub. No.: US 2020/0279415 A1
(43) Pub. Date: Sep. 3, 2020

(54) Efficiently Computed Distance Fields

(71) Applicant: Monotype Imaging Inc., Woburn, MA (US)

(72) Inventors: William Elliott Betts, Andover, MA (US); Robert Joseph Taylor, Groton, MA (US)

(21) Appl. No.: 16/288,736

(22) Filed: Feb. 28, 2019

(51) Int. Cl. G06T 11/20; G06T 7/60

(52) U.S. Cl. CPC G06T 11/203; G06T 2210/21; G06T 7/60

(57) ABSTRACT

A system includes a computing device that includes a memory configured to store instructions. The system also includes a processor to execute the instructions to perform operations that include receiving a collection of line segments representing a glyph space. For each line segment in the collection, operations include determining if each side of the line segment is located within an interior or an exterior of the glyph shape. Operations include determining one or more intersections of the line segments in the collection and an array of points of a grid. Each intersection represents a location that the respective line segment crosses a vertical or horizontal centerline of a point included in the points of the array. For each point included in the points of the array and along the centerline of the respective point, operations include determining a distance between the respective point and one of the one or more intersections. For each point in the array of points, operations assigning a distance field value based on the distance that represents a minimum distance between the respective point and a nearest line segment of the line segment collection. The distance field value also represents whether the point is located within the interior or the exterior of the glyph shape.

### BACKGROUND

This description relates to employing various techniques to optimize the production of distance field representations to efficiency prepare textual content for presentation.

The astronomical growth of available textual content on the Internet has lead users to demand more variety in expressing this content. Correspondingly, the number of available fonts that can represent this textual content has grown. Along with the many different types of fonts, each font is typically presentable with different typographical emphasis (e.g., bold, italic, etc.). Due to all these font variations, interest is growing to quickly and efficiently prepare fonts for presentation on an end user device.

### SUMMARY

The systems and techniques described below employ one or multiple optimization techniques to efficiently produce distance fields. By allowing a user to limit the number of points (e.g., pixels) being represented in a distance field, less operations need to be executed (e.g., some pixels can be automatically assigned visual properties rather than calculating a distance field value for mapping visual properties to the pixels). Also, the separation between a distance field point (e.g., pixel) and a character outline contour can be used to further limit executed operations. By grouping similar types of points (e.g., pixels that are horizontally closest to the outline contour), additional operations do not need to be executed thereby generating a distance field in an efficient manner while conserving computation resources (e.g., processing time, memory, etc.).

In one aspect, a computing device implemented method includes receiving a collection of line segments representing a glyph space. For each line segment in the collection, the method includes determining if each side of the line segment is located within an interior or an exterior of the glyph shape. The method includes determining one or more intersections of the line segments in the collection and an array of points of a grid. Each intersection represents a location that the respective line segment crosses a vertical or horizontal centerline of a point included in the points of the array. For each point included in the points of the array and along the centerline of the respective point, the method includes determining a distance between the respective point and one of the one or more intersections. For each point in the array of points, the method includes assigning a distance field value based on a distance that represents a minimum distance between the respective point and a nearest line segment of the line segment collection. The distance field value also represents whether the point is located within the interior or the exterior of the glyph shape.

Implementations may include one or more of the following features. The method may further include rendering the distance field values into a distance field image. Assigning the distance field value may be based on an externally specified distance. The distance may be along a first coordinate axis and limits the use of points along a second coordinate axis, which is orthogonal to the first coordinate axis, to reduce computations. The distance field values may be determined by grouping points that are closer to the collection of line segments along a coordinate axis and grouping points that are closer to the collection of line segments along an orthogonal coordinate axis. Non-crossing vectors associated with grouped points may be used to reduce computations. The coordinate axis may be a horizontal axis and the orthogonal coordinate axis may be a vertical axis. Each point in the grid may represent a pixel or a subpixel component. The method may further include assigning a visual property to each distance field value. Determining the collection of line segments to represent the glyph may use a recursive binary subdivision technique. Each point of the grid may represent a subpixel component of a pixel arranged horizontally. Each point of the grid may be represent a subpixel component of a pixel arranged vertically. Each point in the grid may represent a subpixel component of a pixel arranged diagonally. Each point in the grid may represent a subpixel component of a pixel, and an array of subpixels are aligned along an axis and another array of subpixels are aligned along an orthogonal axis.

A system includes a computing device that includes a memory configured to store instructions. The system also includes a processor to execute the instructions to perform operations that include receiving a collection of line segments representing a glyph space. For each line segment in the collection, operations include determining if each side of the line segment is located within an interior or an exterior of the glyph shape. Operations include determining one or more intersections of the line segments in the collection and an array of points of a grid. Each intersection represents a location that the respective line segment crosses a vertical or horizontal centerline of a point included in the points of the array. For each point included in the points of the array and along the centerline of the respective point, operations include determining a distance between the respective point and one of the one or more intersections. For each point in the array of points, operations include assigning a distance field value based on a distance that represents a minimum distance between the respective point and a nearest line segment of the line segment collection. The distance field value also represents whether the point is located within the interior or the exterior of the glyph shape.

Implementations may include one or more of the following features. Operations may further include rendering the distance field values into a distance field image. Assigning the distance field value may be based on an externally specified distance. The distance may be along a first coordinate axis and limits the use of points along a second coordinate axis, which is orthogonal to the first coordinate axis, to reduce computations. The distance field values may be determined by grouping points that are closer to the collection of line segments along a coordinate axis and grouping points that are closer to the collection of line segments along an orthogonal coordinate axis. Non-crossing vectors associated with grouped points may be used to reduce computations. The coordinate axis may be a horizontal axis and the orthogonal coordinate axis may be a vertical axis. Each point in the grid may represent a pixel or a subpixel component. Operations may further include assigning a visual property to each distance field value. Determining the collection of line segments to represent the glyph may use a recursive binary subdivision technique. Each point of the grid may represent a subpixel component of a pixel arranged horizontally. Each point of the grid may be represent a subpixel component of a pixel arranged vertically. Each point in the grid may represent a subpixel component of a pixel arranged diagonally. Each point in the grid may represent a subpixel component of a pixel, and an array of subpixels are aligned along an axis and another array of subpixels are aligned along an orthogonal axis.

In another aspect, a system includes a computing device that includes a memory configured to store instructions. The system also includes a processor to execute the instructions to perform operations that include receiving a collection of line segments representing a glyph space. For each line segment in the collection, operations include determining if each side of the line segment is located within an interior or an exterior of the glyph shape. Operations include determining one or more intersections of the line segments in the collection and an array of points of a grid. Each intersection represents a location that the respective line segment crosses a vertical or horizontal centerline of a point included in the points of the array. For each point included in the points of the array and along the centerline of the respective point, operations include determining a distance between the respective point and one of the one or more intersections. For each point in the array of points, operations include assigning a distance field value based on a distance that represents a minimum distance between the respective point and a nearest line segment of the line segment collection. The distance field value also represents whether the point is located within the interior or the exterior of the glyph shape.

Implementations may include one or more of the following features. Operations may further include rendering the distance field values into a distance field image. Assigning the distance field value may be based on an externally specified distance. The distance may along a first coordinate axis and limits the use of points along a second coordinate axis, which is orthogonal to the first coordinate axis, to reduce computations. The distance field values may be determined by grouping points that are closer to the collection of line segments along a coordinate axis and grouping points that are closer to the collection of line segments along an orthogonal coordinate axis. Non-crossing vectors associated with grouped points may be used to reduce computations. The coordinate axis may be a horizontal axis and the orthogonal coordinate axis may be a vertical axis. Each point in the grid may represent a pixel or a subpixel component. Operations may further include assigning a visual property to each distance field value. Determining the collection of line segments to represent the glyph may use a recursive binary subdivision technique. Each point of the grid may represent a subpixel component of a pixel arranged horizontally. Each point of the grid may be represent a subpixel component of a pixel arranged vertically. Each point in the grid may represent a subpixel component of a pixel arranged diagonally. Each point in the grid may represent a subpixel component of a pixel, and an array of subpixels are aligned along an axis and another array of subpixels are aligned along an orthogonal axis.

These and other aspects, features, and various combinations may be expressed as methods, apparatus, systems, means for performing functions, program products, etc.

Other features and advantages will be apparent from the description and the claims.

### DESCRIPTION OF DRAWINGS

FIG. 1 illustrates a computer system presenting a font editing manager interface.

FIG. 2 illustrates an outline of a glyph being represented by lines and curves.

FIG. 3 illustrates a glyph outline fill rule based on non-zero winding number.

FIG. 4 is a block diagram of a font rendering engine and a data storage archive.

FIG. 5 illustrates curves being represented with line segments and recursive subdivision of a curve.

FIG. 6 illustrates a set of line intersections between lines representing the glyph shape and horizontal pixel centers.

FIG. 7 illustrates a set of line intersections between lines representing the glyph shape and vertical pixel centers.

FIG. 8 illustrates distance values determined along horizontal pixel rows.

FIG. 9 illustrates distance values determined along vertical pixel columns.

FIGS. 10A-B, 11A-E, and 12A-B illustrate determining the minimum distance between a point and the nearest point on the glyph shape.

FIG. 13 illustrates reducing distance field computations based on pixel position.

FIG. 14 illustrates grouping pixels based on the vertical or horizontal closeness to a glyph outline contour.

FIG. 15 illustrates reducing distance field computations based on vectors to the nearest font outline contour that do not cross.

FIG. 16 illustrates visual properties assigned to distance field values.

FIG. 17 illustrates a flow chart of operations executed by a distance field generator.

FIG. 18 illustrates an example of a computing device and a mobile computing device that can be used to implement the techniques described here.

### DETAILED DESCRIPTION

Rendering text on a screen in a timely fashion can be considerably important to viewers. Typically the rendering process calls for associating a stream of encoded numbers representing units of text, for example Unicode code points or another standard, with a representation of the corresponding text shape and producing an image of the shape which can then be imprinted on a display screen. Glyphs can be considered as the representation of a text unit's shape and this shape can be described in a number of ways. For two-dimensional glyphs, the glyph shape is often described as a collection of lines and curves. The curves can be, for example, quadratic or cubic Bezier curves since they are relatively easy to create and control, and their properties facilitate compact representations. The process of converting this collection of geometric objects into an image for subsequent display is referred to as rendering and numerous techniques have been developed for rendering a glyph representation to an image.

In one technique, distance fields are used to represent glyph shapes for rendering text. Techniques described herein provide efficient generation of distance field images from representations of glyph outlines. By reducing computational operations to produce such distance fields, both the time and computational burden can be reduced for rendering anti-aliased text with high quality at multiple aspect sizes.

To provide some context on text representations and rendering, typically a graphic artist will draw representations of glyphs in some media and these representations will be encoded into a set of geometric objects such as lines and curves. The drawings may be created with pen and paper and scanned or they may begin as digital drawings that use control points to specify the properties of the geometric objects. Generally the artist will produce a sufficient number of glyph representations to fully portray a writing system, such as Latin or Arabic or Chinese. Scripts, consisting of a number of glyphs, fully describe the text elements required for a writing system. A particular element of a script may be represented in a number of forms as long as a reader of the writing system can recognize the element. Thus, there is a wide latitude of artistic freedom in representing a script. The method of representing glyphs must accommodate such artistic latitude and the rendering system must be capable of faithfully conveying the resultant glyph images.

Quite often collections of glyph representations are grouped together into font families according to their common appearance. Thus a font family can consist of glyphs organized by weight (thin, regular, bold, etc.), width (condensed, regular, extended, etc.), slant angle (regular, italic, etc.), or style (serif, sans serif, etc.). Font families are generally stylistically consistent so as to convey a sense of unity and purpose of design and give the reader a consistent reading experience.

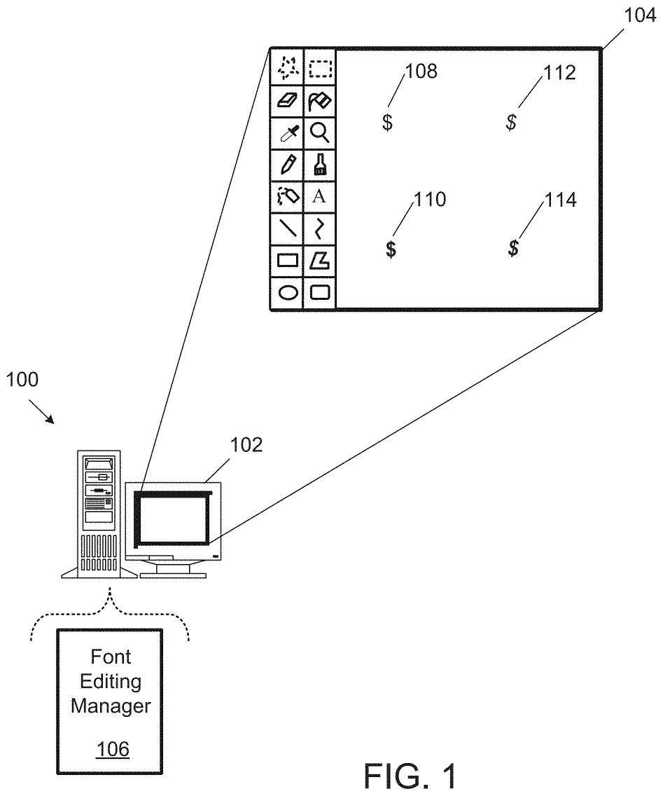

Referring to FIG. 1, a computing device (e.g., computer system 100) includes a display 102 that presents a graphical user interface (GUI) 104 of a font editing manager 106 that is being executed by the computing device. In this example, the GUI 104 allows such graphic artists to review, develop, etc. various types of fonts, glyph shapes within a font family, etc. The font editing manager 106 may provide other types of functionality such as allowing users to review and adjust font family members. For example, different typographical emphasis of a font (e.g., a normal version of the font 108, a bold version of the font 110, an italic version of the font 112, a bold italic version of the font 114, etc.) can be presented for potential adjustments.

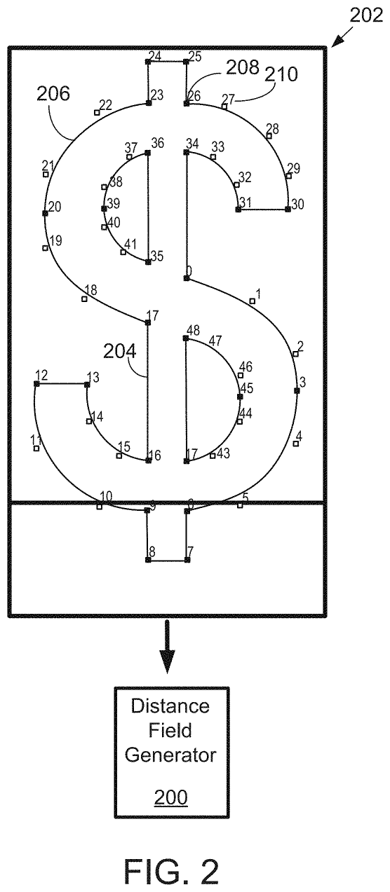

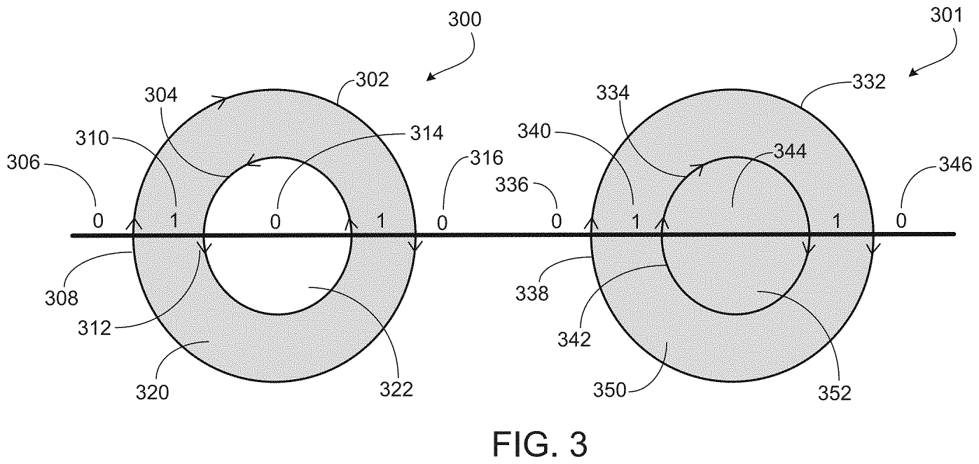

Referring to FIG. 2, a glyph outline 202 can be represented by using lines (e.g., line 204) and curves (e.g., curve 206), such as polynomial Bezier curves. The characteristics of such curves are determined by control points in space that may be either on-curve (as represented by point 208) or off-curve (as represented by point 210). This collection of joined lines and curves is used to represent the boundary between the exterior and interior regions of the glyph shape. A distance field generator 200 (e.g., included in the font editing manager 106) uses a collection of lines and curves to determine the distance to the nearest curve location at each point in space based on rules for how to fill the glyph shape. Referring to FIG. 3, in one arrangement, a fill rule is established for a glyph 300 that specifies how an interior 320 of the glyph is distinguished from an exterior 322 of the glyph so that the glyph shape may be filled (e.g., with a color, shade, etc.). The fill region may represent where to apply ink in a printing process, where to color a pixel on a screen (or apply any type of visual property to the pixel). One fill rule technique is the so-called “nonzero winding rule” used in the OpenType specification for fonts. In this rule, a glyph outline is an ordered, directed set of lines and curves (e.g., such as curves 302, 304 for glyph 300 or curves 332, 334 for glyph 302). Beginning outside the glyph shape, a winding number 306 for glyph 300 (or winding number 336 for glyph 301) is considered to be zero. If one scans across the glyph outline in any direction, typically horizontally or vertically, the winding number is computed based on the number of glyph outlines crossed. Outline crossings in one direction (e.g., direction 308 for glyph 300 and direction 338 for glyph 301) increase the winding number (e.g., winding number 310 for glyph 300 and winding number 340 for glyph 301) by 1. If the next outline crossing is in the opposite direction, the winding number is decreased by 1 (e.g., winding number 314 for glyph 300 is decreased by 1). If the next outline crossing is in the same direction, then the winding number is increased by 1 (e.g., winding number of glyph 301 is increased by 1). The process continues until the winding number is once again zero (e.g., winding number 316 for glyph 300 returns to 1, winding number 346 returns to 1). As such, in general, outlines of a particular direction increase the winding number and outlines of the opposite direction decrease the winding number. Regions that have a non-zero winding number (e.g., region 320 for glyph 300 and region 350 for glyph 301) are considered interior regions and are to be filled. Interior regions associated with a zero winding number are not filled (e.g., zero winding number 314 causes region 322 not to be filled). Interior regions that have a non-zero winding number are filled (e.g., winding number 344 with a values of “2” cause interior region 352 of glyph 301 to be filled). The exact amount of the winding number, other than zero, is generally not important to the fill process. From the process, the sides of a line segment being located within an interior or exterior of a glyph can be determined.

When displaying text to a screen, the glyph outline is often first scaled to a particular size relative to the pixels of the screen. The glyph fill rule determines how particular pixels are assigned a visual property (e.g., a color, grey scale, etc.), for example, by controlling the mixing between the foreground text color and the background color. Fully interior pixels are generally assigned the full amount of foreground text color. Pixels along the edge are assigned a partial mixture of foreground and background color in order to smooth the transition between the two and present a more pleasing and readable contrast. This procedure is commonly called anti-aliasing in reference to concepts from digital sampling theory.

Anti-aliasing of digital text on a screen can be achieved in numerous ways. One approach is to assign a foreground/background mixing value based on the total area of the pixel covered within the interior of the glyph outline. The rendering process determines this area based on the outline boundary as it crosses the pixel. Distance fields can also be used to determine the foreground/background mixing value by mapping the pixel's distance field value to a corresponding mixing value (or other type of visual property). A two-dimensional (2D) distance field specifies the minimum distance to an outline at every point in space. A signed 2D distance field assigns a positive or negative sign to the minimum distance based on some convention. For example, in a typical signed distance field, interior locations may be assigned positive values and exterior locations may be assigned negative values. The reverse convention (or other types of conventions) may also be applied. In both cases, a distance of zero is considered exactly on the outline boundary. Similarly, the convention may specify that distances above a certain value are considered interior and distances below a certain value are exterior while distances at exactly that value are exactly on the outline boundary.

Various degrees of anti-aliasing can be achieved by mapping a distance field value to a visual property such as a foreground/background mixing value. This mapping can take many forms, including linear and non-linear mappings, and the mapping is generally limited in space relative to the outline boundary. For digitally rendered text the nature of the mapping controls the appearance of the glyphs and their edge characteristics. For example, if the mapping describes a gradual transition from background to foreground over a larger distance, then the edge of the rendered glyph appears softer and less definitive. If the transition occurs over a smaller distance range, the glyph appearance is sharper and more definitive, trending toward being discrete or binary.

Equidistant contours within the distance field represent self-similar representations of the glyph outline. Using these contours as the basis for the anti-aliasing mapping can result in glyph appearances that are smaller, e.g., with thinner stems, or larger, e.g., with thicker stems. The location of the glyph outline is effectively shifted uniformly to an equidistant location. At the same time the transition from background to foreground can change nature. The combination of the two adjustments in glyph rendering can lead to a wide range of rendered glyph appearances from a single glyph outline.

A digitally sampled, signed 2D distance field is an image in which each pixel represents the minimum distance to the glyph outline and in which the sign of the value represents whether the pixel center is inside or outside the glyph outline, in accordance with the fill rule that is applicable to the outline. In this case the continuous values of the distance field are sampled and encoded as values in the distance field image. Note that the digital sampling does not have to correspond to a particular screen representation nor does it have to be uniform or rectangular in nature. Various discrete sampling schemes can be used and these affect the mapping between a sampled distance value and a visual property (e.g., a screen mixing value).

Similar to pixels, such techniques can also be employed for other types of points used to define distance fields. For example, sub pixels can be used as distance field points. Digital screens often use sub pixel color channels to represent a perceived color of the pixel. Typically these are red, green, and blue channels that when combined can map out a wide range of colors. These subpixel elements may consist of various topologies such as horizontal bars, vertical bars, diagonally arranged, hexagonal regions, etc. with the constraint that they uniformly cover the screen and are sufficiently small so as to not be individually perceived. Distance field values can be computed for each subpixel element and a mapping between distance field value and subpixel intensity can be established. Controlling subpixel intensities relative to the glyph outline results in a more faithful perceived representation of the glyph shape.

A common use of digitally sampled, signed 2D distance fields is to encode the distance field image into a texture map and then map that texture onto a set of vertices in 2D or three dimensional (3D) space. In doing so the texture map and distance values may be interpolated. One or more interpolation schemes may be applied. One interpolation scheme that can be employed is bilinear interpolation in which the values of four adjacent pixels are combined in each pixel. Bi-cubic interpolation is another employable technique to combine distance field values encoded into a texture map in order to more faithfully represent the underlying non-sampled distance field.

Following interpolation, the resulting distance value for a given fragment in 2D or 3D space is mapped to a visual property (e.g., a foreground/background mixing value) for the screen. Applying the mapping to interpolated distance values results in non-pixelated edges at a wide variety of scaling's between the underlying world space and screen space. This allows a distance field that has been sampled using one sampling scheme to be used as the basis for rendering text at a wide variety of text to screen size ratios, without loss of quality due to pixelization at high zoom values. Conversely, at small zoom levels, the glyph rendering appears consistent across pixel boundaries and aliasing effects due to sampling the glyph outline are minimized. These are considerable benefits of using distance fields to render text in 2D and 3D graphical applications.

Determining a sampled 2D signed distance field value can be considered a non-trivial operation, particularly when attempting to conserve computational resources. For some techniques, a set of cells are used to enclose the outline of a glyph object. Distance values for sampled pixels are reconstructed from the cells and interior/exterior regions are determined relative to the cells to determine a signed distance. However, when different parts of the glyph outline overlap each other, erroneous results may be produced in the distance field. Since overlapping contours occur in a number of fonts, such errors can frequently occur. By consolidating the overlapping region, the erroneous results can be addressed, but through a computationally expensive process.

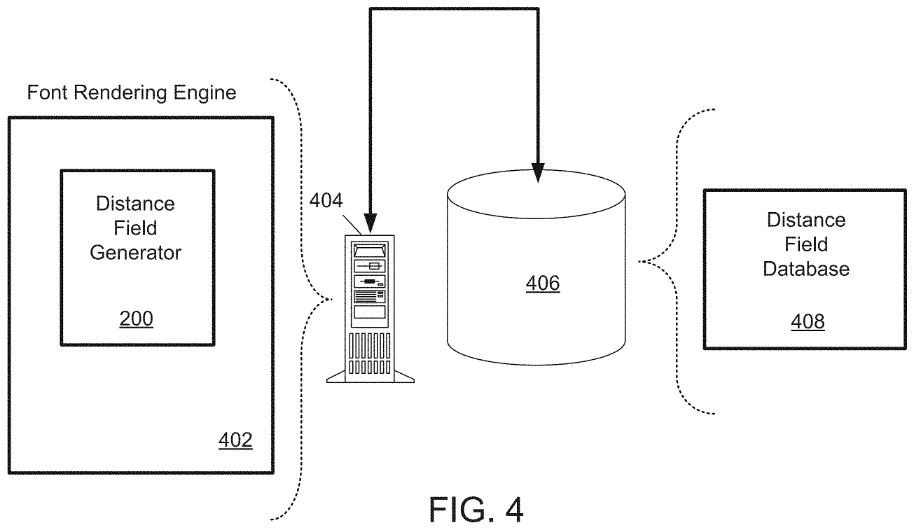

Referring to FIG. 4, a distance field generator 200 is included in a font rendering engine 402 (e.g., contained in the font editing manager 106) that is executed by a computer system 404 that is connected to a storage device 406. The distance field generator 200 generates signed distance fields in an optimized and efficient manner. Further the operations of the distance field generator 200 address overlapping contours within a glyph outline. The distance field generator 200 produces accurate distance field values that can be used (e.g., assigned visual properties) and stored (e.g., in a distance field database 408 included in the storage device 406). The techniques used by the distance field generator 200 may be applied to various type of distance field points; for example, operations be executed on pixels, subpixels, etc. that are assigned signed distance field values which can be mapped to one or more visual properties (e.g., colors, grey scale levels, etc.). Other types of computational architectures may be employed, for example distributed processing techniques can be used in which distance fields are computed across multiple computing devices (e.g., servers, user devices, etc.).

Referring briefly back to FIG. 2, a graphical representation of glyph shape outline 202 is provided to the distance field generator 200. The glyph shape outline 202 (e.g., of a dollar sign character) includes contours made up of various lines and curves that are scaled to a desired size relative to a set of pixels in the final distance field image. One or more techniques may be used to represent the glyph shape outline 202, for example, one or more geometric objects can be used to describe a portion or multiple portions of the outline. Additionally, the geometric objects can describe boundaries between interior and exterior regions of the glyph, etc.

In general, the distance field generator 200 employs a heuristic approach to reduce the number of unneeded computations of distance field values. For example, the distance field generator 200 attempts to compute distance field values that will actually be used while attempting to not compute distance field values that will not be used (or are simply not needed). The output of the distance field generator 200 is a signed distance field image that corresponds to the scaled outline, and the distance field values may be encoded to the image by using one or more techniques.

To initiate the creation of the distance field for outline 202, the size of output distance field image is allocated (e.g., a scale is selected by the user). In general, the contours of the outline 202 can be considered a collection of lines, curves, etc. such as quadratic Bezier curves or cubic Bezier curves. Other types of curves can be also used by the distance field generator 200 as long as the curves can be mathematically represented. As illustrated in the figure, the outline 202 includes a number of curves (e.g., curve 206) to represent the glyph (e.g., of the dollar sign character).

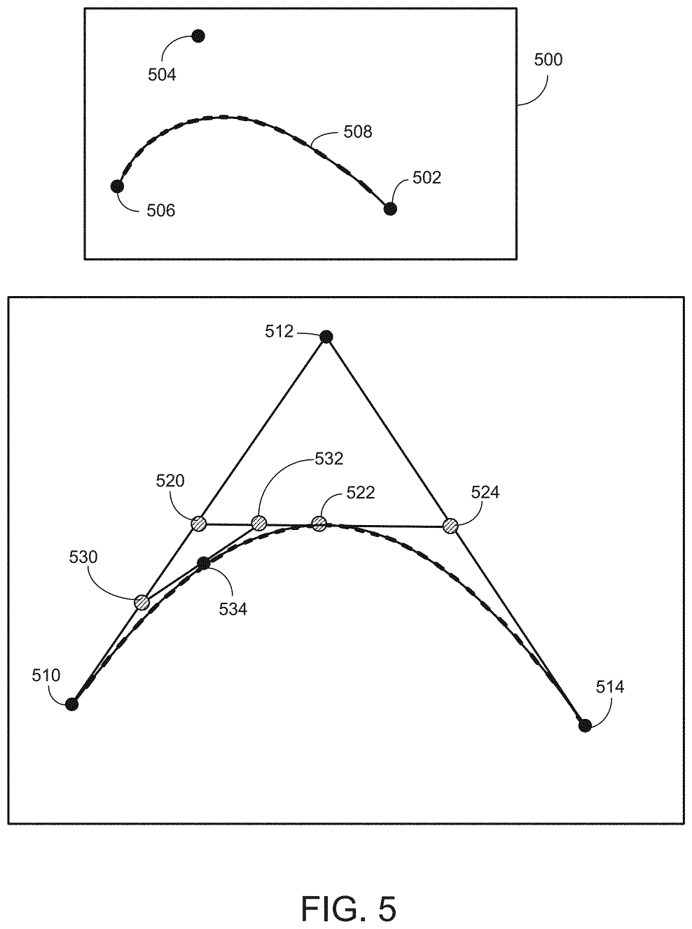

Referring to FIG. 5, a curve is specified by on-curve control points 502 and 506 with the degree of curvature controlled by off-curve point 504. The distance field generator 200 evaluates the curves of the outline 202 into line segments (e.g., line segment 508) that approximate the curve (within a tolerance level). One or more techniques may be employed to approximate the curves with line segments, and these techniques may depend upon the type or types of curves to represent the outline. For example, for quadratic Bezier curves or cubic Bezier curves, the distance field generator may employ recursive bisection using a technique such as De Casteljau's technique to efficiently generate lines segments from these Bezier curves. Such techniques (e.g., a recursive binary subdivision technique) are described in U.S. patent application Ser. No. 14/993,424, titled “Converting Font Contour Curves”, and filed on 12 Jan. 2016, and U.S. patent application Ser. No. 15/850,853, titled “Harmonizing Font Contours”, and filed on 21 Dec. 2017, the content of both being incorporated by reference herein. Typically, by increasing the number of line segments to represent a curve, the line segments more closely track the shape of the curve. In some arrangements a tolerance value can be set (e.g., set by the user for the font rendering engine 402) to control the number of line segments produced for approximating the shape of a curve. In some arrangements the selected tolerance can cause different numbers of line segments to be produced in different areas of an outline. For example, in areas of a glyph outline where a high degree of curvature is present (e.g., area 206 shown in FIG. 2) more line segments may be needed to approximate the curve, while in areas of lower curvature (e.g., area 204 also shown in FIG. 2), fewer line segments may be needed.

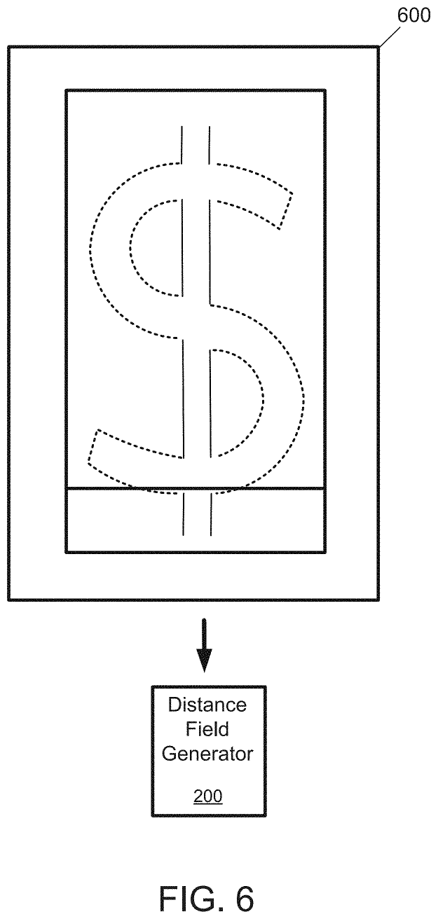

Once the line segments have been produced to appropriately represent the curves of the outline (based on the tolerance), the distance field generator 200 performs calculations based upon the rows of pixels and columns of pixels that are used to represent the distance field image of the glyph outline. In this example, operations associated with the pixel rows are first executed; however, operations associated with pixel columns may be initially executed. In this example, for each line segment in a set of line segments that approximate a contour of the outline, the distance field generator 200 calculates the line segment's horizontal intersection or intersections 600 (shown in FIG. 6) with each row of points (e.g., pixels) and adds the results to a representation of all intersections for a given row of pixels. Typically these data are stored, for example, in the distance field database 408 (shown in FIG. 4).

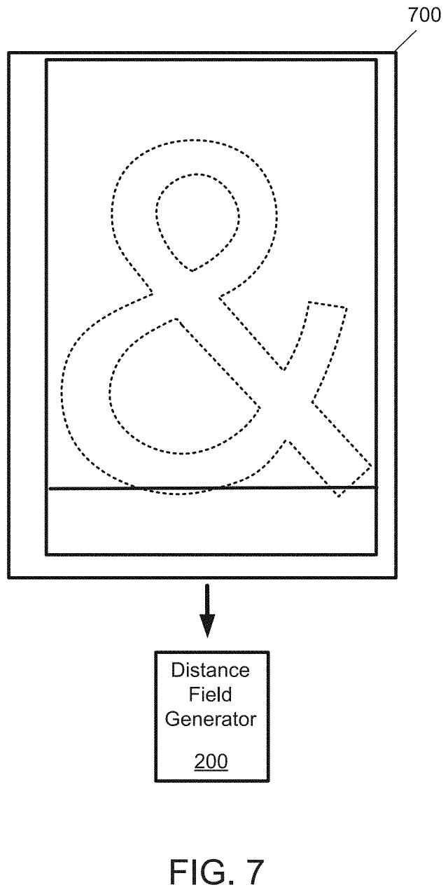

Referring to FIG. 7, similar operations are executed by the distance field generator 200 for vertical intersections with pixel columns. In this figure an outline 700 of another glyph (e.g., an ampersand character) is presented and is processed by the distance field generator 200. Similar to the rows of points (e.g., pixels) with respect to FIG. 6, for each line segment in a set of line segments that approximate a contour of the outline 700, the distance field generator 200 calculates the line segment's vertical intersection or intersections with each column of points (e.g., pixels) and adds the results to produce a representation of all the intersections for a given column of pixels. Also, similar to the data associated with the pixel rows, the distance field generator 200 stores the pixel column data in the distance field database 408 on the storage device 406.

Once pixel row and pixel column data has been calculated and stored, the distance field generator 200 executes operations to produce a distance field. For example, the distance field generator 200 produces a 2D data grid to store the horizontal distance from each corresponding pixel to the closest contour of the outline. The extent of this 2D data grid is the same as the final distance field image produced by the distance field generator 200 based on the outline extents and the distance limit supplied.

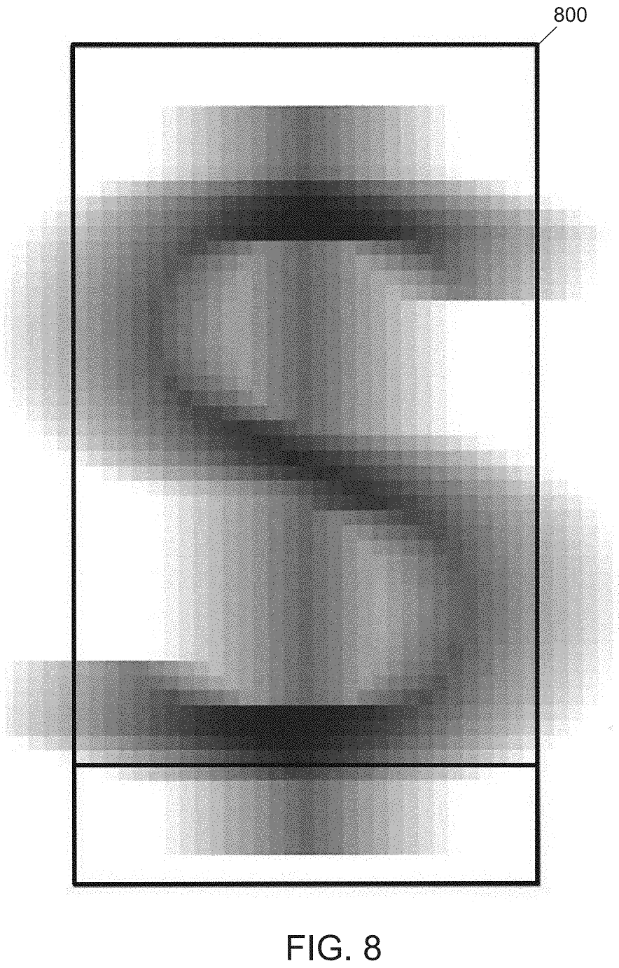

With the 2D data grid produced, the distance field generator 200 executes operations for each row of horizontal intersections calculated and stored. In particular, the horizontal intersections are sorted from low to high. Next any intersections that do not represent a change in winding direction are removed. By executing this operation, the distance field generator 200 accounts for overlapping contours of the outline. Stepping through each row of pixels, the distance field generator 200 assigns each pixel the square of the distance from the pixel to the nearest intersection. The distance field generator 200 also tracks whether the pixel is inside or outside the contour. From these operations, a set of distances are measured horizontally for each pixel center to the nearest boundary of the outline. Referring to FIG. 8, a representation 800 represents the horizontal distance data.

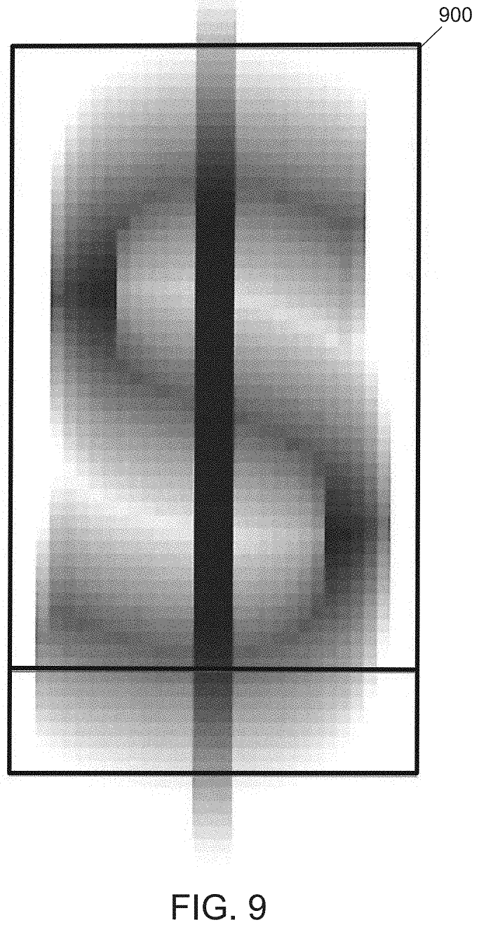

The distance field generator 200 also executes similar operations for the stored vertical data. In particular, for each column of vertical intersections, the distance field generator 200 sorts the vertical intersections from low to high. The distance field generator 200 also removes any intersections that do not represent a change in winding direction. From this operation, the distance field generator also accounts for overlapping contours. Stepping through each column of pixels, the distance field generator 200 assigns each pixel the square of the distance from the pixel to nearest intersection. From these operations, a set of distances are measured vertically for each pixel center to the nearest boundary of the outline. Referring to FIG. 9, a representation 900 presents the vertical distance data.

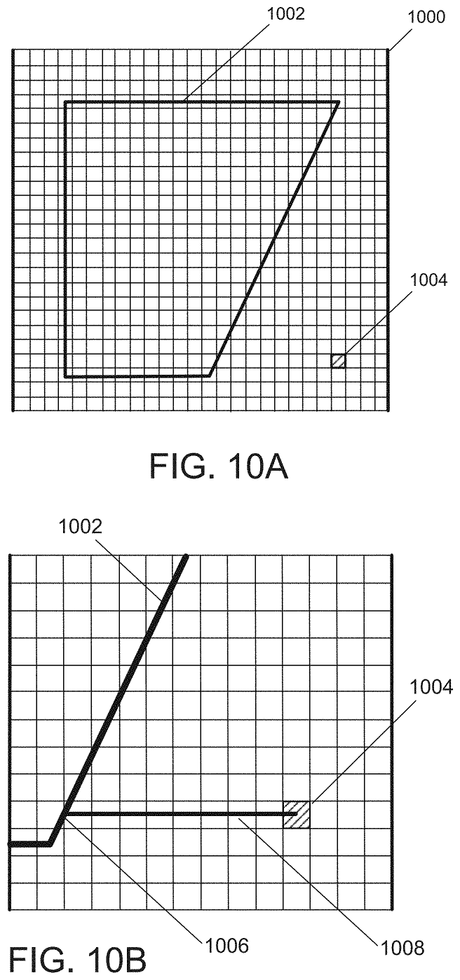

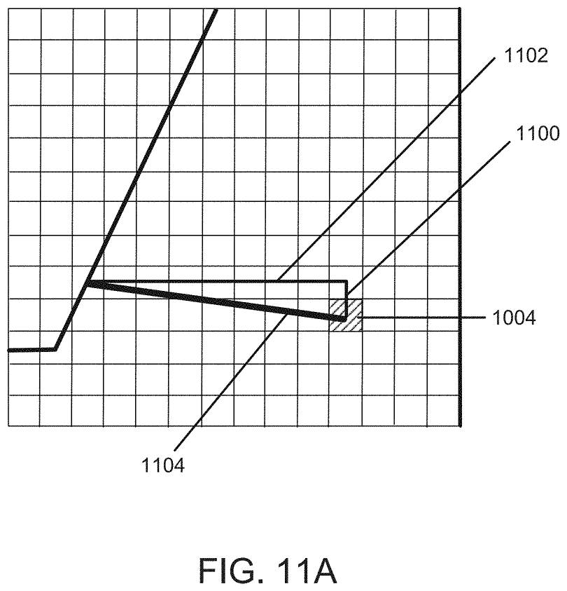

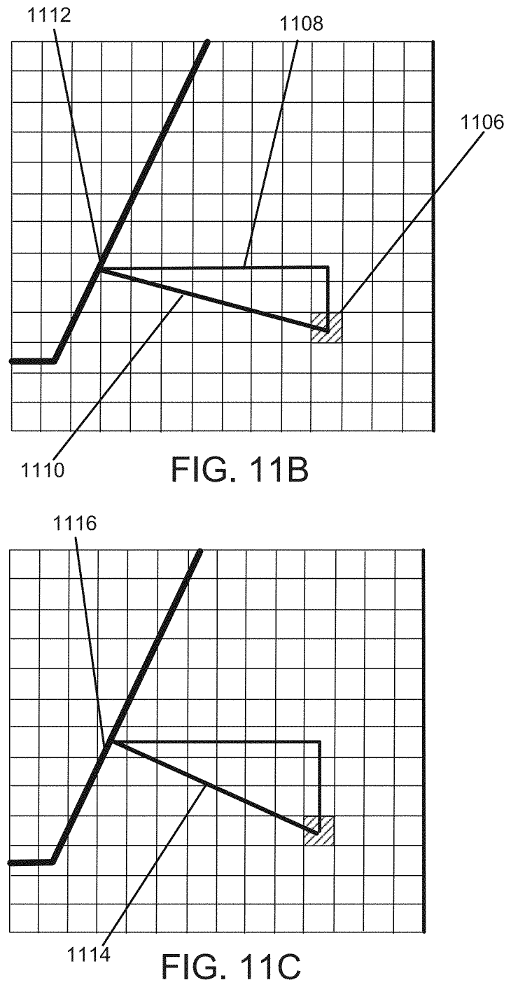

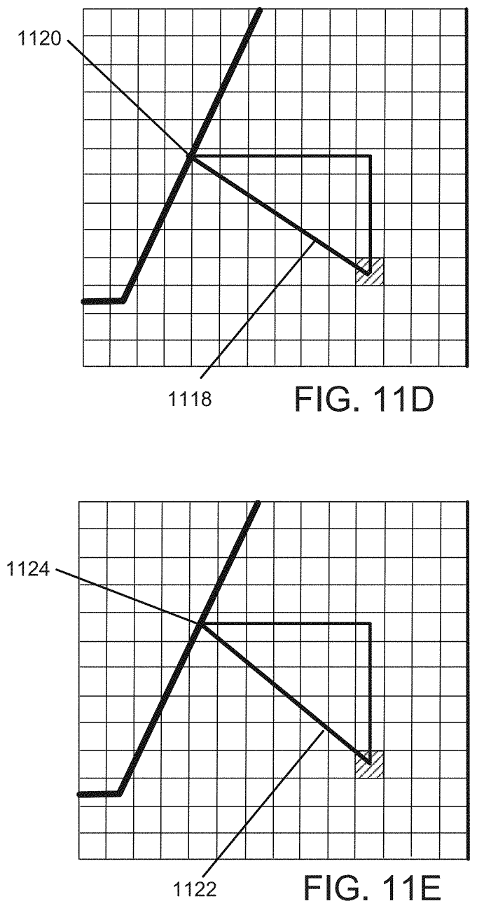

Referring to FIGS. 10, 11, and 12, a series of graphical illustrations are presented that represent operations of the distance field generator 200 for efficiently calculating the final distances for a distance field. By executing these operations, the distance field generator 200 determines the minimum distance from a given point (e.g., pixel, subpixel, etc.) to the closest contour of the glyph outline. To determine the distance, the distance field generator 200 uses Pythagoras' theorem that states the square of the hypotenuse of a right triangle is the sum of the squares of the other two sides of the right triangle. Considering the distance from a pixel to the contour as being the hypotenuse of a right triangle, the minimum distance between the pixel and the contour (again the hypotenuse of the right triangle) can be found by determining the minimum of the sum of the square of the other two sides (of the right triangle). One of the other sides of the triangle is the horizontal distance from the pixel to the contour, and the second of the other sides (of the triangle) is the integer distance (vertically stepping up or down) to the next pixel (e.g., a pixel directly above, two pixels directly above, a pixel directly below, two pixels directly below, etc.). From the minimum sum (of the squared distances) for the other sides, the squared minimum distance to the contour is similarly determined. Further, rather than computing the square root of each distance (which involves executing inefficient operations), squared distances are used along with efficiently executed summing operations. Once the squared minimum distance is efficiently determined, then a single square can be executed, thereby conserving computational resources.

Referring to FIG. 10A, a two dimensional pixel grid 1000 presents an outline contour 1002 (e.g., of a glyph) that has a relatively simple closed shaped geometry. For demonstrative purposes, a single pixel 1004 is highlighted in the 2D pixel grid 1000. By executing operations, the distance field generator 200 efficiently determines the minimum distance from the pixel 1004 to the closest portion of the outline contour. Referring to FIG. 10B, operations of the distance field generator 200 start by determining the horizontal distance from the center of the pixel 1004 to a point 1006 where a centerline 1008 (from the pixel center) intersects the outline contour 1002. Referring to FIG. 11A, the distance field generator 200 next steps in the vertical direction to form a vertical side 1100 of a right triangle while a previously determined horizontal distance (from a pixel vertically adjacent to pixel 1004 to the intersection point with the outline contour) provides a horizontal side 1102 of the right triangle. In this particular example, the generator 200 steps up one pixel in the vertical direction to form the vertical side 1100. As such, the vertical distance is an integer number of pixels (in this case one pixel) and the horizontal distance has been previously determined. The squared length of a hypotenuse 1104 of the right triangle can be determined from the sum of the squared lengths of the two sides 1100 and 1102. By further stepping vertically from the pixel, the squared length of the hypotenuse of the next formed right triangle can be determined. Referring to FIG. 11B, the vertical side is incremented by another pixel so a two pixel offset is the length of a vertical side 1106. The previously determined horizontal distance from this offset pixel to the intersection point with the outline contour 1002 provides the length of a horizontal side 1108 of the right triangle. From these squared lengths, the squared length of the hypotenuse 1110 can be calculated to provide a measure of the distance from the pixel to the outline contour at a point 1112. Referring to FIG. 11C, 11D, and 11E, the distance field generator 200 continues to increment the vertical offset (e.g., a 3-pixel vertical offset in FIG. 11C, a 4-pixel vertical offset in FIG. 11D, and a 5-pixel vertical offset in FIG. 11E). For each increment increase, the squared length of a hypotenuse is calculated that represents the distance between the pixel and a point on the outline contour (e.g., a hypotenuse 1114 provides a distance to point 1116 for a 3-pixel offset, a hypotenuse 1118 provides a distance to a point 1120 for a 4-pixel offset, and a hypotenuse 1122 provides a distance to a point 1124 for a 5-pixel offset). The distance field generator 200 continues to increment the vertical offset to determine additional distances.

In a similar manner the generator also increments in the other vertical direction (e.g., below the pixel 1004) to determine the squared length of corresponding hypotenuses. Referring to FIG. 12A, for a one-pixel offset below the pixel 1004, a vertical side 1200 is formed. From the previously determined horizontal distance to the contour outline, a horizontal side 1202 is determined and the squared length of a hypotenuse 1204 can be calculated. Referring to FIG. 12B, the downward pixel offset is incremented once more (for a two-pixel offset) to produce a vertical side 1206. Extending beyond the lower vertical limit of the contour 1002, no horizontal distance was previously determined, and a hypotenuse cannot be calculated for this pixel increment. By incrementing above and below a pixel (e.g., pixel 1004), the distance field generator 200 can determine the minimum distance between the pixel and the outline contour (e.g., calculating the square root of the minimum squared distance value).

In order to determine the minimum distance for each pixel, the distance field generator 200 would need to execute a considerable number of operations given the number of vertical offsets for each pixel. For example, probing an entire column of pixels containing the initial pixel 1004, the performance of the generator would be slow, perhaps having a performance of O(N²). However, one or more techniques may be implemented in the distance field generator 200 to improve the performance of the distance field calculations. For example, three optimizing techniques may be used individually or in concert by the distance field generator 200 to improve performance.

For one technique, one or more conditions may be applied to limit the number of pixels for which a distance is determined (for the distance field). By reducing the number of pixels, less operations are executed by the distance field generator 200 and the distance field can be computed in a more efficient manner. For one example, the distance field values may not be calculated for field points (e.g., pixels) that are positioned at particular locations. The visual property of pixels sufficiently outside the outline may saturate to a uniform color (e.g. a color such as white), once beyond this limit, distance calculations are redundant. Similarly, pixels located inside the outline may similarly be assigned visual property (e.g., a color such as black) without needing to calculate a distance value. As such, conditions can be defined to limit the pixels for which distance field values are calculated. In some arrangements, the conditions can be user selected; for example, upper, lower, left, and right limits (e.g., thresholds) can be selected by a user (e.g., externally specified) and distance field values are not calculated for pixels located outside these limits. Similarly a user can select limits on the interior of a contour (e.g., the interior of the character “O”) for which distance field values are not calculated (and visual properties may automatically be assigned). In one arrangement, a graphical user interface (GUI) may be employed to allow a user to graphically select limits with a pointing device (e.g., select an upper pixel row and a lower pixel row with a mouse) for which distance field values are not calculated. Setting such limits (e.g., thresholds), the number of computations executed by the distance field generator 200 may be reduced and thereby increase the efficiency for generating distance fields.

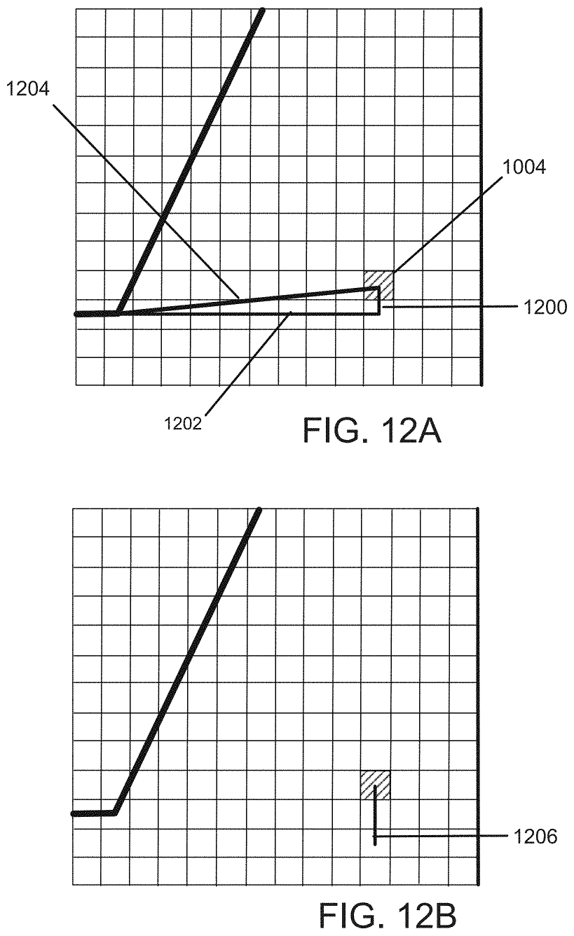

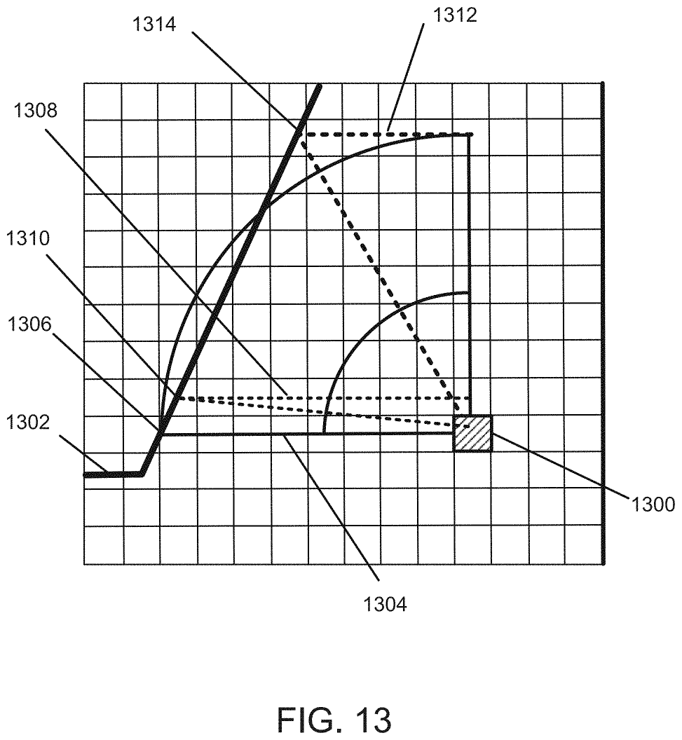

Referring to FIG. 13, a graphical representation is presented that illustrates a second technique to improve distance field computational efficiency. Probing a vertical distance that is greater than the original horizontal distance (separating a pixel and a contour) cannot produce a squared sum (e.g., a hypotenuse of a right triangle) that is smaller than the squared sum (e.g., hypotenuse) for vertical distances less or equal to the horizontal distance. So a distance along a coordinate axis (e.g., a distance along the horizontal axis from a pixel to a contour) limits operations executed along an orthogonal axis (e.g., the vertical axis). As shown in the figure, a pixel 1300 is selected for determining the minimum distance to a contour 1302 (for a distance field value). As represented by a horizontal line 1304, the pixel 1300 is located a particular horizontal distance (e.g., eight pixel widths) from an intersection point 1306 on the contour 1302. Based upon this horizontal distance (e.g., eight pixel widths), the number of vertical steps is limited for computing the sums of squared right triangle sides (and corresponding, the hypotenuse of the right triangle). In this example, since the horizontal separation distance between the pixel 1300 and the contour intersection point 1306 is eight pixel widths, computations (to sum right triangle squared sides) are only executed for eight upward increments (above the pixel 1300) and for eight downward increments (below the pixel 1300). In the figure, the eight upward increments (above the pixel 1300) are illustrated. In particular, right triangle 1308 includes one side with a vertical length of one pixel (from the pixel 1300) and a horizontal length that horizontally extends from this vertical height to an intersection point 1310. Stepping up the entire eight pixels, a right triangle 1312 includes a side that with a vertical length that is eight pixels (from the pixel 1300) and a horizontal length that extends from this higher vertical height to the an intersection point 1314. As such, squared sides are summed by the distance field generator 200 for eight right triangles that extend vertically upward from the pixel 1000. In a similar manner, the distance field generator 200 also sums the squared sides of eight right triangles that extend vertically downward below the pixel 1300 (through these right triangles are not illustrated in the figure). By limiting the upward and downward vertical stepping from each pixel (e.g., eight increments up and eight increments down) for summing the squared sides of right triangles, a considerable number of computations are not executed by the distance field generator 200, thereby saving considerable resources (e.g., computational time, memory, etc.). Further, by reducing the number of computations, the efficiency of producing a distance field is improved.

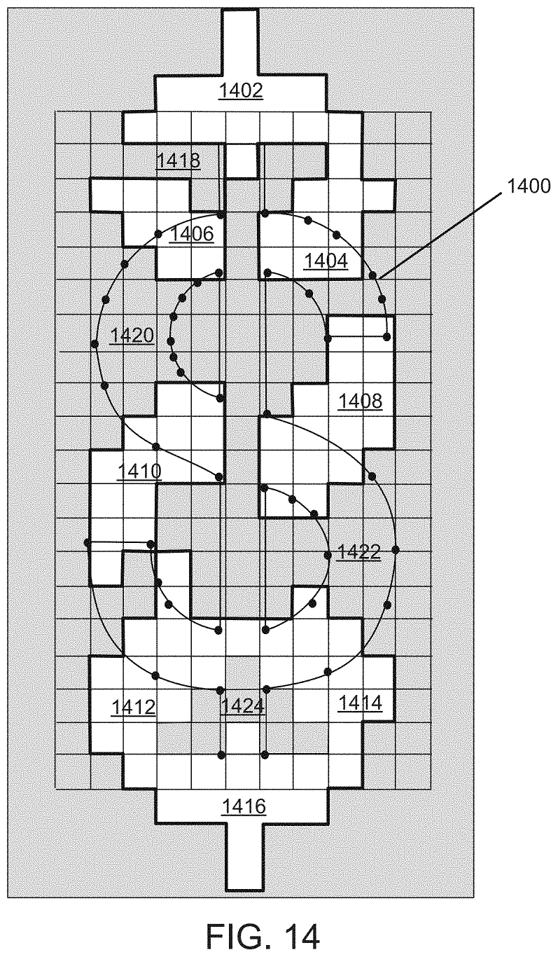

Referring to FIG. 14, another graphical representation is presented that illustrates a third optimization technique to improve the operations of the distance field generator 200. In general, pixels that are horizontally closest or vertically closest to a contour tend to be located in groups based on the shape of the contour. In this illustrated example, a glyph outline 1400 for a dollar sign character is illustrated and pixels that are horizontally closest to the contour (e.g., along a coordinate axis—the horizontal axis) are shown in one shade (e.g., grey) and pixels that are vertically closest to the contour (e.g., along an orthogonal axis—the vertical axis) are shown in another shade (e.g., white). Based upon the shape of the outline 1400, the pixels appear in groups; for example, pixel groups 1402, 1404, 1406, 1408, 1410, 1412, 1414, and 1416 represent pixels that are vertically closest to the outline 1400 and pixel groups 1418, 1420, 1422, and 1424 are horizontally closest to the outline 1400. Based upon these groupings, the distance field generator 200 can perform operations for pixels in a common group in a computationally efficient manner. For example, a row of pixels, which are each identified as being horizontally closest to the outline 1400, can be processed together, or a column of pixels that are identified as being vertically closest to the outline 202 can be processed together. Processed in this manner, further gains can be achieved due the nature of adjacent pixels of similar type (e.g., pixel that are vertically closest to the outline or pixels that are horizontally closest to the outline). For example, vectors that represent the minimum distance to the outline for similar pixel types typically do not cross each other (non-crossing vectors). As such, a vector representing the minimum distance for pixel can be used to limit the computations needed to calculate the minimum distance (to the outline) for an adjacent pixel. Identifying such limits can further reduce the operations executed by the distance field generator 200 and further improve the efficiency of distance field generation.

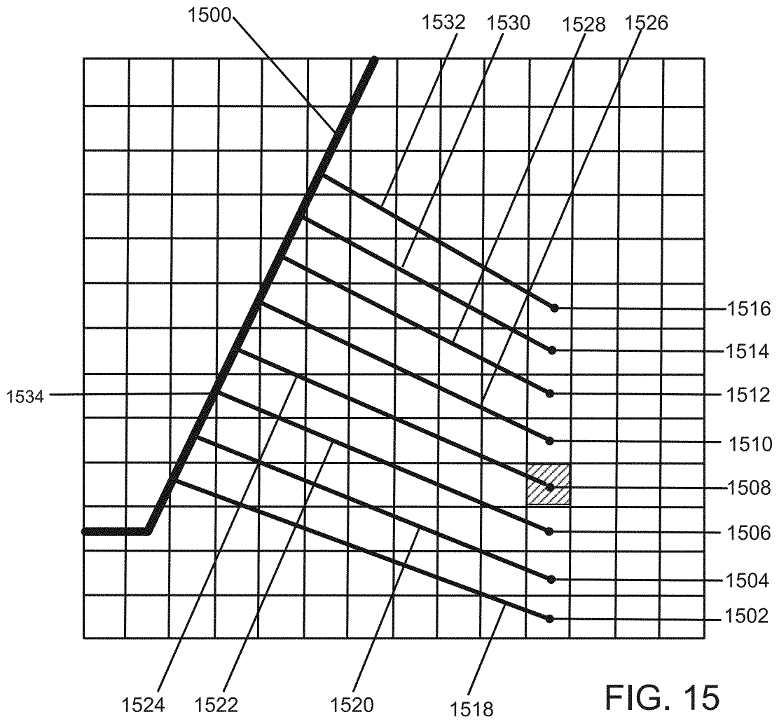

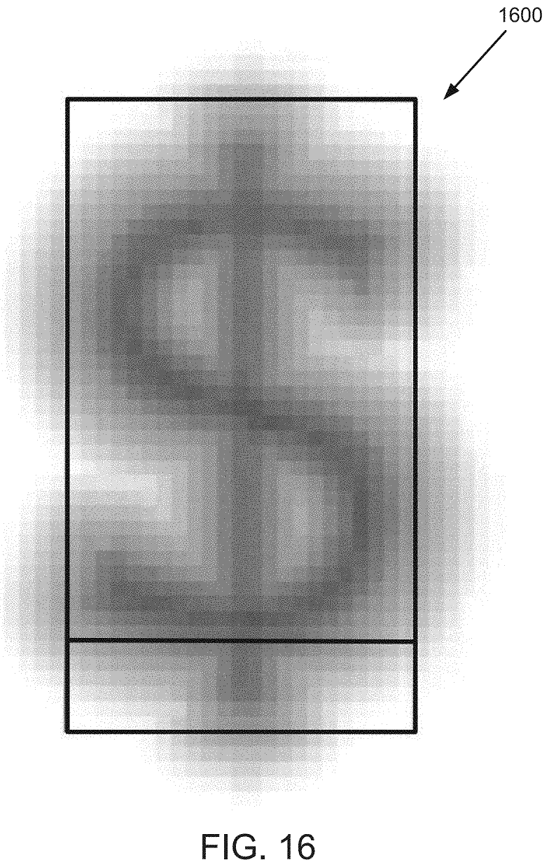

Referring to FIG. 15, a series of pixels are illustrated along with lines that represent the minimum distance value from a corresponding pixel to a contour 1500. In particular, pixels 1502, 1504, 1506, 1508, 1510, 1512, 1514, and 1516 are presented along with corresponding lines 1518, 1520, 1522, 1524, 1526, 1528, 1530, and 1532. As mentioned above, for pixels of the similar type (e.g., pixels horizontally closest to a contour) the vectors of minimum distances (from the pixels to the contour) generally don't cross. As such the minimum distance vector for a pixel can be used to limit calculations performed (by the distance field generator 200) for an adjacent pixel. For example, for the pixel 1506 the line 1522 represents the minimum distance to the contour 1500. Considering that line 1522 intersects the contour 1500 at point 1534, the computations to determine the minimum distance between the pixel 1508 and the contour 1500 can be reduced. For example, since the minimum distance line for pixel 1508 cannot cross line 1522, the intersection point 1534 (of line 1522) can be used as a lower limit for calculating the minimum distance line for pixel 1508. Being the lower limit, computations regarding pixel 1508 only need to be executed that involve intersection points located at positions above intersection point 1534 (since the resulting minimum distance line 1524 cannot cross the minimum distance line 1522). In this example, the intersection point 1534 is located at a vertical position that is three pixels above pixel 1506 (and two pixels above pixel 1508). Thus, computations to determine the minimum distance for the pixel 1508 can start at a vertical position that is three pixels above pixel 1508 since the minimum distance line 1524 (for the pixel 1508) cannot cross the minimum distance line 1522 (for the adjacent pixel 1506). By setting the lower limit for computations, additional operations of the distance field generator 200 may be reduced to further improve efficiency. Similar operations can be employed for vertical fields, again operations are performed on squared distance values to determine the squared minimum distance (e.g., the squared length of a right triangle hypotenuse). For efficiency, once the final squared distance field values are determined, then the distance field generator 200 can perform square root operations to determine the distance values. While such square roots are relatively inefficient, these operations are executed towards the end of the process to minimize their effects on the overall operations of the distance field generator 200. Referring to FIG. 16, once the final distance field values are determined, the distance field generator 200 can assign a visual property to each value to produce a distance field image 1300. For example, a color, grey scale value (e.g., between white and black), etc. can be assigned based upon the determined distance values for presentation of the glyph (e.g., a dollar sign character represented by the distance field image 1600).

While the example illustrated in FIGS. 13, 15, and 16 used pixels to generate a distance field, the described technique can also be employed for other type of points used to define a distance field. For example, the technique may be applied to the generation of subpixel distance fields in an analogous fashion. Resulting subpixel distance field values can similarly be stored in a distance field image. The subpixel components of this image may be arranged in a various ways, depending on the application. For example, to compute horizontally arranged subpixels, three distance field values are computed per each pixel. Horizontal distances are computed to each subpixel center along the vertical centerline of the row of pixels. The sum of the square of the distances for each subpixel component is then computed in a similar manner as described above for pixel centers. Likewise, if the subpixel components are arranged vertically within the pixel, the square of the distance to each vertical subpixel component is computed along the horizontal line from the component to where it intersects the nearest glyph outline line segment. Vertical distances from this subpixel component are then computed and the minimum distance to the outline from the subpixel component is found.

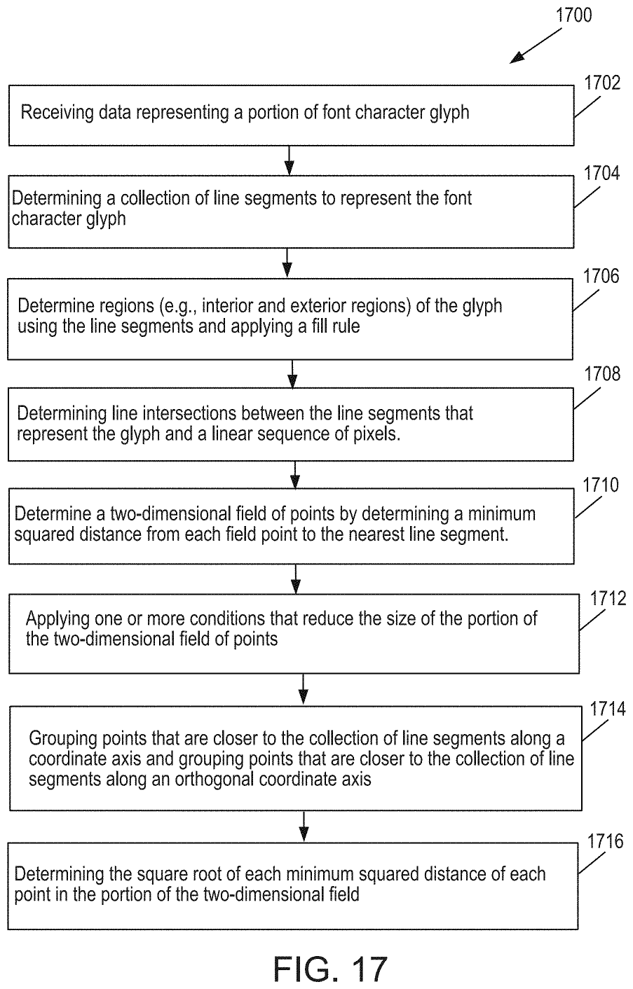

Referring to FIG. 17, a flowchart 1700 represents operations of the distance field generator 200 included in the font rendering engine 402 (shown in FIG. 4). Operations of the distance field generator 200 are typically executed by a single computing device (e.g., the computer 404); however, operations of the generator may be executed by multiple computing devices. Along with being executed at a single site, execution of operations may be distributed among two or more locations.

Operations of the distance field generator include receiving 1702 data representing a glyph. For example, data that represents curves of a glyph contour (e.g., quadratic Bezier curves, cubic Bezier curves, etc.) may be received for processing. Operations also include determining 1704 a collection of line segments to represent the shape of the glyph. For example, a recursive bisection using a De Casteljau's technique can be used to efficiently generate lines segments from these Bezier curves. Operations also include determining 1706 regions (e.g., interior and exterior regions) of the glyph by using the line segments and according to a fill rule. For example, a winding number can be determined and used to identify one or more regions to be filled or not filled (e.g., sides of line segments located interior or exterior to a glyph). Operations also include determining 1708 a set of line intersections between the line segments that represent the glyph shape and a linear sequence (e.g., array) of points (e.g., pixels). For example, a set of line intersections can be determined between the line segments that represent the glyph shape and center lines of horizontal rows of pixels. Similarly a set of line intersections can be determined between the line segments that represent the glyph shape and center lines of vertical columns of points (e.g., pixels). Operations also include determining 1710 a two-dimensional field of points by determining a minimum squared distance from each field point to the nearest line segment. For example, distance field a distance field for a horizontal two-dimensional field of points is generated by determining a minimum squared distance from each point in the horizontal rows of points (e.g., pixels) to nearest line segment, the minimum squared distance being determined from the respective point and the intersection point of the nearest line segment along the center line of the horizontal row of points (e.g., pixels). Similarly, a distance field for a vertical two-dimensional field of points is generated by determining a minimum squared distance from each point in the vertical column of points (e.g., pixels) to the nearest line segment, the minimum squared distance being determined from the respective point and the intersection point of the nearest line segment along the center line of the vertical column of points (e.g., pixels). In some arrangements, these operations can be considered as determining a minimum squared distance from each point in a two-dimensional field of points to a collection of line segments, the minimum squared distance being determined from the respective point to the nearest line segment (of the collection of line segments) along a coordinate axis. The distance horizontally separating a point (e.g., pixel) from a contour can limit the operations to find the minimum distance to the contour (e.g., limit the number vertical steps above and below the pixel for calculating distances). Similarly, the distance vertically separating a point (e.g., pixel) from a contour can limit the operations to find the minimum distance to the contour (e.g., limit the number horizontal steps left and right of the pixel for calculating distances).

Operations to determine the distance field also include applying 1712 one or more conditions that reduce the size of the portion of the two-dimensional field of points. For example, a user can select (e.g., graphically with a pointing device) one more limits, thresholds, etc. (e.g., an upper limit, a lower limit, and interior limit) for which minimum distances need not be computed for pixels that exceed the limits. Operations to determine the distance field also include grouping 1714 points that are closer to the collection of line segments along the coordinate axis and grouping points that are closer to the collection of line segments along an orthogonal coordinate axis. For example, pixels that are horizontally closest to the contour can be grouped and processed together, and similarly pixels that are vertically closest to the contour can be grouped and processed together. Operations of the distance field generator also include determining 1716 the square root of each minimum squared distance of each point in the portion of the two-dimensional field. For example, relatively inefficient square root operations can be executed for each pixel only after the squared minimum distances are efficiently calculated for these considerable number of pixels by using summing operations (associated with right triangles).

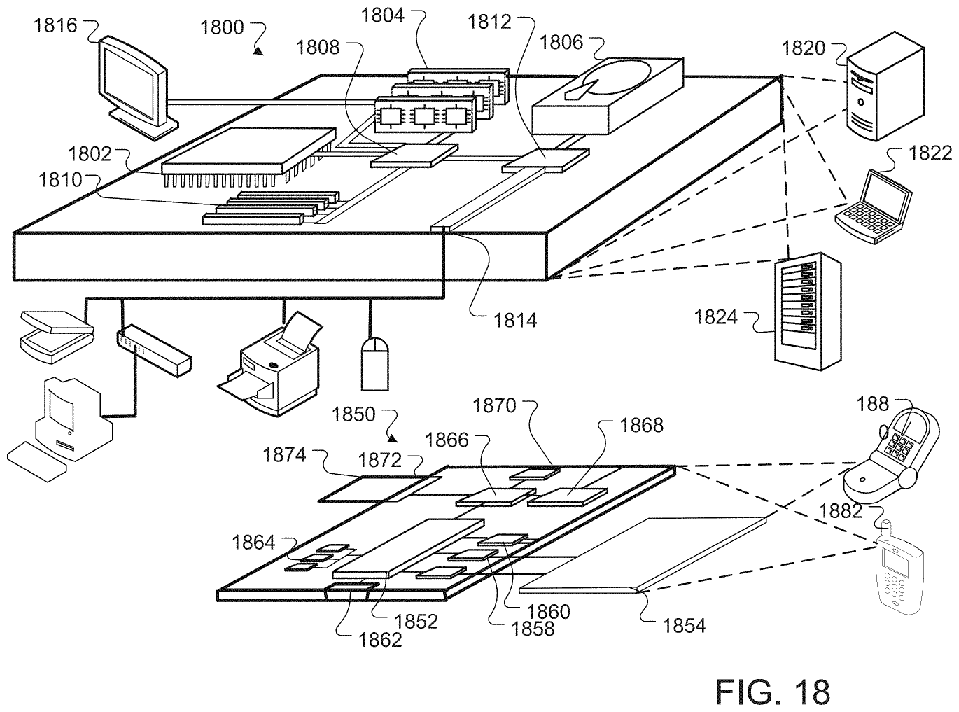

FIG. 18 shows an example of example computer device 1800 and example mobile computer device 1850, which can be used to implement the techniques described herein. For example, a portion or all of the operations of the distance field generator 200 (shown in FIG. 2) may be executed by the computer device 1800 and/or the mobile computer device 1850. Computing device 1800 is intended to represent various forms of digital computers, including, e.g., laptops, desktops, workstations, personal digital assistants, servers, blade servers, mainframes, and other appropriate computers. Computing device 1850 is intended to represent various forms of mobile devices, including, e.g., personal digital assistants, tablet computing devices, cellular telephones, smartphones, and other similar computing devices. The components shown here, their connections and relationships, and their functions, are meant to be examples only, and are not meant to limit implementations of the techniques described and/or claimed in this document.

Computing device 1800 includes processor 1802, memory 1804, storage device 1806, high-speed interface 1808 connecting to memory 1804 and high-speed expansion ports 1810, and low speed interface 1812 connecting to low speed bus 1814 and storage device 1806. Each of components 1802, 1804, 1806, 1808, 1810, and 1812, are interconnected using various busses, and can be mounted on a common motherboard or in other manners as appropriate. Processor 1802 can process instructions for execution within computing device 1800, including instructions stored in memory 1804 or on storage device 1806 to display graphical data for a GUI on an external input/output device, including, e.g., display 1816 coupled to high speed interface 1508. In other implementations, multiple processors and/or multiple busses can be used, as appropriate, along with multiple memories and types of memory. Also, multiple computing devices 1800 can be connected, with each device providing portions of the necessary operations (e.g., as a server bank, a group of blade servers, or a multi-processor system).

Memory 1804 stores data within computing device 1800. In one implementation, memory 1804 is a volatile memory unit or units. In another implementation, memory 1804 is a non-volatile memory unit or units. Memory 1804 also can be another form of computer-readable medium (e.g., a magnetic or optical disk. Memory 1804 may be non-transitory.)

Storage device 1806 is capable of providing mass storage for computing device 1400. In one implementation, storage device 1806 can be or contain a computer-readable medium (e.g., a floppy disk device, a hard disk device, an optical disk device, or a tape device, a flash memory or other similar solid state memory device, or an array of devices, such as devices in a storage area network or other configurations.) A computer program product can be tangibly embodied in a data carrier. The computer program product also can contain instructions that, when executed, perform one or more methods (e.g., those described above.) The data carrier is a computer- or machine-readable medium, (e.g., memory 1804, storage device 1806, memory on processor 1802, and the like.)

High-speed controller 1808 manages bandwidth-intensive operations for computing device 1800, while low speed controller 1812 manages lower bandwidth-intensive operations. Such allocation of functions is an example only. In one implementation, high-speed controller 1708 is coupled to memory 1804, display 1816 (e.g., through a graphics processor or accelerator), and to high-speed expansion ports 1810, which can accept various expansion cards (not shown). In the implementation, low-speed controller 1812 is coupled to storage device 1806 and low-speed expansion port 1814. The low-speed expansion port, which can include various communication ports (e.g., USB, Bluetooth®, Ethernet, wireless Ethernet), can be coupled to one or more input/output devices, (e.g., a keyboard, a pointing device, a scanner, or a networking device including a switch or router, e.g., through a network adapter.)

Computing device 1800 can be implemented in a number of different forms, as shown in the figure. For example, it can be implemented as standard server 1820, or multiple times in a group of such servers. It also can be implemented as part of rack server system 1824. In addition or as an alternative, it can be implemented in a personal computer (e.g., laptop computer 1822.) In some examples, components from computing device 1800 can be combined with other components in a mobile device (not shown), e.g., device 1850. Each of such devices can contain one or more of computing device 1800, 1850, and an entire system can be made up of multiple computing devices 1500, 1550 communicating with each other.

Computing device 1850 includes processor 1852, memory 1864, an input/output device (e.g., display 1854, communication interface 1866, and transceiver 1868) among other components. Device 1850 also can be provided with a storage device, (e.g., a microdrive or other device) to provide additional storage. Each of components 1850, 1852, 1864, 1854, 1866, and 1868, are interconnected using various buses, and several of the components can be mounted on a common motherboard or in other manners as appropriate.

Processor 1852 can execute instructions within computing device 1850, including instructions stored in memory 1864. The processor can be implemented as a chipset of chips that include separate and multiple analog and digital processors. The processor can provide, for example, for coordination of the other components of device 1850, e.g., control of user interfaces, applications run by device 1850, and wireless communication by device 1850.

Processor 1852 can communicate with a user through control interface 1858 and display interface 1856 coupled to display 1854. Display 1854 can be, for example, a TFT LCD (Thin-Film-Transistor Liquid Crystal Display) or an OLED (Organic Light Emitting Diode) display, or other appropriate display technology. Display interface 1856 can comprise appropriate circuitry for driving display 1854 to present graphical and other data to a user. Control interface 1858 can receive commands from a user and convert them for submission to processor 1852. In addition, external interface 1862 can communicate with processor 1842, so as to enable near area communication of device 1850 with other devices. External interface 1862 can provide, for example, for wired communication in some implementations, or for wireless communication in other implementations, and multiple interfaces also can be used.

Memory 1864 stores data within computing device 1850. Memory 1864 can be implemented as one or more of a computer-readable medium or media, a volatile memory unit or units, or a non-volatile memory unit or units. Expansion memory 1874 also can be provided and connected to device 1850 through expansion interface 1872, which can include, for example, a SIMM (Single In Line Memory Module) card interface. Such expansion memory 1874 can provide extra storage space for device 1850, or also can store applications or other data for device 1850. Specifically, expansion memory 1874 can include instructions to carry out or supplement the processes described above, and can include secure data also. Thus, for example, expansion memory 1874 can be provided as a security module for device 1850, and can be programmed with instructions that permit secure use of device 1850. In addition, secure applications can be provided through the SIMM cards, along with additional data, (e.g., placing identifying data on the SIMM card in a non-hackable manner.)

The memory can include, for example, flash memory and/or NVRAM memory, as discussed below. In one implementation, a computer program product is tangibly embodied in a data carrier. The computer program product contains instructions that, when executed, perform one or more methods, e.g., those described above. The data carrier is a computer- or machine-readable medium (e.g., memory 1864, expansion memory 1874, and/or memory on processor 1852), which can be received, for example, over transceiver 1868 or external interface 1862.

Device 1850 can communicate wirelessly through communication interface 1866, which can include digital signal processing circuitry where necessary. Communication interface 1866 can provide for communications under various modes or protocols (e.g., GSM voice calls, SMS, EMS, or MMS messaging, CDMA, TDMA, PDC, WCDMA, CDMA2000, or GPRS, among others.) Such communication can occur, for example, through radio-frequency transceiver 1868. In addition, short-range communication can occur, e.g., using a Bluetooth®, WiFi, or other such transceiver (not shown). In addition, GPS (Global Positioning System) receiver module 1870 can provide additional navigation- and location-related wireless data to device 1850, which can be used as appropriate by applications running on device 1850. Sensors and modules such as cameras, microphones, compasses, accelerators (for orientation sensing), etc. may be included in the device.

Device 1850 also can communicate audibly using audio codec 1860, which can receive spoken data from a user and convert it to usable digital data. Audio codec 1860 can likewise generate audible sound for a user, (e.g., through a speaker in a handset of device 1850.) Such sound can include sound from voice telephone calls, can include recorded sound (e.g., voice messages, music files, and the like) and also can include sound generated by applications operating on device 1850.

Computing device 1850 can be implemented in a number of different forms, as shown in the figure. For example, it can be implemented as cellular telephone 1880. It also can be implemented as part of smartphone 1882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor. The programmable processor can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a device for displaying data to the user (e.g., a CRT (cathode ray tube) or LCD (liquid crystal display) monitor), and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a backend component (e.g., as a data server), or that includes a middleware component (e.g., an application server), or that includes a frontend component (e.g., a client computer having a user interface or a Web browser through which a user can interact with an implementation of the systems and techniques described here), or a combination of such back end, middleware, or frontend components. The components of the system can be interconnected by a form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A computing device implemented method comprising:
receiving a collection of line segments representing a glyph space;
for each line segment in the collection, determining if each side of the line segment is located within an interior or an exterior of the glyph shape;
determining one or more intersections of the line segments in the collection and an array of points of a grid, wherein each intersection represents a location that the respective line segment crosses a vertical or horizontal centerline of a point included in the points of the array;
for each point included in the points of the array and along the centerline of the respective point, determining a distance between the respective point and one of the one or more intersections; and
for each point in the array of points, assigning a distance field value based on a distance that represents a minimum distance between the respective point and a nearest line segment of the line segment collection, the distance field value also represents whether the point is located within the interior or the exterior of the glyph shape.

2. The computing device implemented method of claim 1, further comprising: rendering the distance field values into a distance field image.

3. The computing device implemented method of claim 1, wherein assigning the distance field value is based on an externally specified threshold.

4. The computing device implemented method of claim 1, wherein the distance is along a first coordinate axis and limits the use of points along a second coordinate axis, which is orthogonal to the first coordinate axis, to reduce computations.

5. The computing device implemented method of claim 1, wherein the distance field values are determined by grouping points that are closer to the collection of line segments along a coordinate axis and grouping points that are closer to the collection of line segments along an orthogonal coordinate axis.

6. The computing device implemented method of claim 5, wherein non-crossing vectors associated with grouped points are used to reduce computations.

7. The computing device implemented method of claim 5, wherein the coordinate axis is a horizontal axis and the orthogonal coordinate axis is a vertical axis.

8. The computing device implemented method of claim 1, wherein each point in the grid represents a pixel or a subpixel component.

9. The computing device implemented method of claim 1, further comprising assigning a visual property to each distance field value.

10. The computing device implemented method of claim 1, wherein determining the collection of line segments to represent the glyph uses a recursive binary subdivision technique.

11. The computing device implemented method of claim 1, wherein each point of the grid represents a subpixel component of a pixel arranged horizontally.

12. The computing device implemented method of claim 1, wherein each point of the grid represents a subpixel component of a pixel arranged vertically.

13. The computing device implemented method of claim 1, wherein each point in the grid represents a subpixel component of a pixel arranged diagonally.

14. The computing device implemented method of claim 1, wherein each point in the grid represents a subpixel component of a pixel, wherein an array of subpixels is aligned along an axis and another array of subpixels is aligned along an orthogonal axis.

15. A system comprising:
a computing device comprising:
memory configured to store instructions; and
a processor to execute the instructions to perform operations comprising:
receiving a collection of line segments representing a glyph space;
for each line segment in the collection, determining if each side of the line segment is located within an interior or an exterior of the glyph shape;
determining one or more intersections of the line segments in the collection and an array of points of a grid, wherein each intersection represents a location that the respective line segment crosses a vertical or horizontal centerline of a point included in the points of the array;
for each point included in the points of the array and along the centerline of the respective point, determining a distance between the respective point and one of the one or more intersections; and
for each point in the array of points, assigning a distance field value based on a distance that represents a minimum distance between the respective point and a nearest line segment of the line segment collection, the distance field value also represents whether the point is located within the interior or the exterior of the glyph shape.

16. The system of claim 15, further comprising: rendering the distance field values into a distance field image.

17. The system of claim 15, wherein assigning the distance field value is based on an externally specified threshold.

18. The system of claim 15, wherein the distance is along a first coordinate axis and limits the use of points along a second coordinate axis, which is orthogonal to the first coordinate axis, to reduce computations.

19. The system of claim 15, wherein the distance field values are determined by grouping points that are closer to the collection of line segments along a coordinate axis and grouping points that are closer to the collection of line segments along an orthogonal coordinate axis.

20. The system of claim 19, non-crossing vectors associated with grouped points are used to reduce computations.

21. The system of claim 19, wherein the coordinate axis is a horizontal axis and the orthogonal coordinate axis is a vertical axis.

22. The system of claim 15, wherein each point in the grid represents a pixel or a subpixel component.

23. The system of claim 15, further comprising assigning a visual property to each distance field value.

24. The system of claim 15, wherein determining the collection of line segments to represent the glyph uses a recursive binary subdivision technique.

25. The system of claim 15, wherein each point of the grid represents a subpixel component of a pixel arranged horizontally.

26. The system of claim 15, wherein each point of the grid represents a subpixel component of a pixel arranged vertically.

27. The system of claim 15, wherein each point in the grid represents a subpixel component of a pixel arranged diagonally.

28. The system of claim 15, wherein each point in the grid represents a subpixel component of a pixel, wherein an array of subpixels is aligned along an axis and another array of subpixels is aligned along an orthogonal axis.

29. One or more computer readable media storing instructions that are executable by a processing device, and upon such execution cause the processing device to perform operations comprising:
receiving a collection of line segments representing a glyph space;
for each line segment in the collection, determining if each side of the line segment is located within an interior or an exterior of the glyph shape;
determining one or more intersections of the line segments in the collection and an array of points of a grid, wherein each intersection represents a location that the respective line segment crosses a vertical or horizontal centerline of a point included in the points of the array;
for each point included in the points of the array and along the centerline of the respective point, determining a distance between the respective point and one of the one or more intersections; and
for each point in the array of points, assigning a distance field value based on a distance that represents a minimum distance between the respective point and a nearest line segment of the line segment collection, the distance field value also represents whether the point is located within the interior or the exterior of the glyph shape.

30. The computer readable media of claim 29, further comprising: rendering the distance field values into a distance field image.

31. The computer readable media of claim 29, wherein assigning the distance field value is based on an externally specified threshold.

32. The computer readable media of claim 29, wherein the distance is along a first coordinate axis and limits the use of points along a second coordinate axis, which is orthogonal to the first coordinate axis, to reduce computations.

33. The computer readable media of claim 29, wherein the distance field values are determined by grouping points that are closer to the collection of line segments along a coordinate axis and grouping points that are closer to the collection of line segments along an orthogonal coordinate axis.

34. The computer readable media of claim 33, non-crossing vectors associated with grouped points are used to reduce computations.

35. The computer readable media of claim 33, wherein the coordinate axis is a horizontal axis and the orthogonal coordinate axis is a vertical axis.

36. The computer readable media of claim 29, wherein each point in the grid represents a pixel or a subpixel component.

37. The computer readable media of claim 29, further comprising assigning a visual property to each distance field value.

38. The computer readable media of claim 29, wherein determining the collection of line segments to represent the glyph uses a recursive binary subdivision technique.

39. The computer readable media of claim 29, wherein each point of the grid represents a subpixel component of a pixel arranged horizontally.

40. The computer readable media of claim 29, wherein each point of the grid represents a subpixel component of a pixel arranged vertically.

41. The computer readable media of claim 29, wherein each point in the grid represents a subpixel component of a pixel arranged diagonally.

42. The computer readable media of claim 29, wherein each point in the grid represents a subpixel component of a pixel, wherein an array of subpixels is aligned along an axis and another array of subpixels is aligned along an orthogonal axis.
